(19) United States
(12) Patent Application Publication
(10) Pub. No.: US 2026/0101283 A1
(43) Pub. Date: Apr. 9, 2026

(54) CONFIGURATION, ACTIVATION, AND OPERATION FOR LOW POWER-WAKE UP SIGNALS

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Hemant SAGGAR, San Diego, CA (US); Kazuki TAKEDA, Minato-ku (JP); Igor GUTMAN, Hod HaSharon (IL); Junyi LI, Greentown, PA (US); Tao LUO, San Diego, CA (US)

(21) Appl. No.: 19/228,688

(22) Filed: Jun. 4, 2025

Related U.S. Application Data
(60) Provisional application No. 63/704,993, filed on Oct. 8, 2024.

(51) Int. Cl. H04W 52/02; H04W 72/1263; H04W 72/23; H04W 76/28

(52) U.S. Cl. CPC H04W 52/0235; H04W 72/1263; H04W 72/23; H04W 76/28

(57) ABSTRACT

A user equipment (UE) may be configured with a first set of low-power wake-up signals (LP-WUS) monitoring occasions that are used to trigger physical downlink control channel (PDCCH) monitoring occasions associated with a discontinuous reception (DRX) configuration (e.g., DRX-related LP-WUS monitoring occasions), and a second set of LP-WUS monitoring occasions that are used to trigger PDCCH monitoring occasions that are separate from the DRX configuration (e.g., non-DRX LP-WUS monitoring occasions). Within each monitoring occasion, the UE may monitor, search, or receive LP-WUSs within configured time and frequency resources. The UE may then be configured to monitor both sets of LP-WUS monitoring occasions, and trigger DRX-related or non-DRX-related PDCCH monitoring occasions based on whether an LP-WUS is received within the first set of LP-WUS monitoring occasions associated the DRX configuration or the second set of LP-WUS monitoring occasions that are separate from the DRX configuration.

### CROSS REFERENCES

The present Application for Patent claims benefit of U.S. Provisional Patent Application No. 63/704,993 by RYU et al., entitled “CONFIGURATION, ACTIVATION, AND OPERATION FOR LOW POWER-WAKE UP SIGNALS,” filed Oct. 8, 2024, assigned to the assignee hereof, and expressly incorporated herein.

### FIELD OF TECHNOLOGY

The following relates to wireless communications, including configuration, activation, and operation for low power-wake up signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more configurations of a first low power-wakeup signal (LP-WUS) configuration type or one or more configurations of a second LP-WUS configuration type, where the first LP-WUS configuration type includes one or more parameters associated with LP-WUS-triggered monitoring of connected-mode discontinuous reception (C-DRX) downlink control resources, and where the second LP-WUS configuration type includes one or more parameters associated with LP-WUS-triggered monitoring of non-C-DRX downlink control resources, receiving an activation command that activates monitoring of LP-WUS monitoring occasions according to a first configuration of the one or more configurations of the first LP-WUS configuration type, a second configuration of the one or more configurations of the second LP-WUS configuration type, or both, and receiving a physical downlink control channel (PDCCH) during a PDCCH monitoring occasion in accordance with the first configuration, the second configuration, or both.

A UE for wireless communications is described. The UE may include one or more memories storing processor executable code, and one or more processors coupled with the one or more memories. The one or more processors may individually or collectively be operable to execute the code to cause the UE to receive one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources, receive an activation command that activates monitoring of LP-WUS monitoring occasions according to a first configuration of the one or more configurations of the first LP-WUS configuration type, a second configuration of the one or more configurations of the second LP-WUS configuration type, or both, and receive a PDCCH during a PDCCH monitoring occasion in accordance with the first configuration, the second configuration, or both.

Another UE for wireless communications is described. The UE may include means for receiving one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources, means for receiving an activation command that activates monitoring of LP-WUS monitoring occasions according to a first configuration of the one or more configurations of the first LP-WUS configuration type, a second configuration of the one or more configurations of the second LP-WUS configuration type, or both, and means for receiving a PDCCH during a PDCCH monitoring occasion in accordance with the first configuration, the second configuration, or both.

A non-transitory computer-readable medium storing code for wireless communications is described. The code may include instructions executable by one or more processors to receive one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources, receive an activation command that activates monitoring of LP-WUS monitoring occasions according to a first configuration of the one or more configurations of the first LP-WUS configuration type, a second configuration of the one or more configurations of the second LP-WUS configuration type, or both, and receive a PDCCH during a PDCCH monitoring occasion in accordance with the first configuration, the second configuration, or both.

Some examples of the method, UEs, and non-transitory computer-readable medium described herein may further include operations, features, means, or instructions for receiving both the one or more configurations of the first LP-WUS configuration type and the one or more configurations of the second LP-WUS configuration type.

Some examples of the method, UEs, and non-transitory computer-readable medium described herein may further include operations, features, means, or instructions for receiving an LP-WUS during the LP-WUS monitoring occasions in accordance with the first configuration, the second configuration, or both, where the LP-WUS triggers the PDCCH monitoring occasion during a time period based on an LP-WUS offset.

In some examples of the method, UEs, and non-transitory computer-readable medium described herein, and the method, apparatuses, and non-transitory computer-readable medium may include further operations, features, means, or instructions for extending a time period associated with the active discontinuous reception (DRX) cycle, extending a time period associated with the PDCCH monitoring occasion, stopping all DRX timers associated with the active DRX cycle, and stopping all PDCCH monitoring occasions.

In some examples of the method, UEs, and non-transitory computer-readable medium described herein, the activation command includes a command to skip LP-WUS monitoring occasions for a period of time or a quantity of LP-WUS monitoring occasions, a command to change a periodicity or an offset of the LP-WUS monitoring occasions, a command to modify configurations associated with subsequent LP-WUS monitoring occasions, an indication of a PDCCH monitoring delay, or combinations thereof.

Some examples of the method, UEs, and non-transitory computer-readable medium described herein may further include operations, features, means, or instructions for receiving a second activation command, where a configuration activated by the activation command remains active or may be deactivated based on the second activation command.

Some examples of the method, UEs, and non-transitory computer-readable medium described herein may further include operations, features, means, or instructions for transmitting a request to activate or deactivate the one or more configurations of the first LP-WUS configuration type or the one or more configurations of the second LP-WUS configuration type.

In some examples of the method, UEs, and non-transitory computer-readable medium described herein, the request to activate or deactivate may be based on a capability of the UE.

Some examples of the method, UEs, and non-transitory computer-readable medium described herein may further include operations, features, means, or instructions for transmitting a scheduling request, where the scheduling request includes the request to activate or deactivate.

In some examples of the method, UEs, and non-transitory computer-readable medium described herein, a medium access control-control element includes the activation command.

In some examples of the method, UEs, and non-transitory computer-readable medium described herein, the one or more parameters associated with the first LP-WUS configuration type and the one or more parameters associated with the second LP-WUS configuration type include a periodicity and an offset of LP-WUS monitoring resources.

In some examples of the method, UEs, and non-transitory computer-readable medium described herein, a quantity of the one or more configurations of the first LP-WUS configuration type and a quantity of the one or more configurations of the second LP-WUS configuration type may be based on a capability of the UE.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports configuration, activation, and operation for low power-wake up signals in accordance with one or more aspects of the present disclosure.

FIG. 2 shows an example of a wireless communications system that supports configuration, activation, and operation for low power-wake up signals in accordance with one or more aspects of the present disclosure.

FIG. 3 shows an example of a DRX configuration that supports configuration, activation, and operation for low power-wake up signals in accordance with one or more aspects of the present disclosure.

FIG. 4 shows an example of a monitoring configuration that supports configuration, activation, and operation for low power-wake up signals in accordance with one or more aspects of the present disclosure.

FIG. 5 shows an example of a process flow that supports configuration, activation, and operation for low power-wake up signals in accordance with one or more aspects of the present disclosure.

FIGS. 6 and 7 show block diagrams of devices that support configuration, activation, and operation for low power-wake up signals in accordance with one or more aspects of the present disclosure.

FIG. 8 shows a block diagram of a communications manager that supports configuration, activation, and operation for low power-wake up signals in accordance with one or more aspects of the present disclosure.

FIG. 9 shows a diagram of a system including a device that supports configuration, activation, and operation for low power-wake up signals in accordance with one or more aspects of the present disclosure.

FIG. 10 shows a flowchart illustrating methods that support configuration, activation, and operation for low power-wake up signals in accordance with one or more aspects of the present disclosure.

### DETAILED DESCRIPTION

In some wireless communications systems, wireless devices (e.g., user equipments (UEs)) may utilize different mechanisms for reducing power consumption. For example, UEs may operate according to a discontinuous reception (DRX) configuration, where the UE transitions between “active states” (higher power consumption) and “inactive states” (lower power consumption). In the context of a DRX configuration, the UE may be expected to monitor for downlink control information (DCI) of power saving (DCP) messages during an inactive state to determine whether or not the network has data to communicate to UE, and therefore determine whether the UE is expected to monitor for physical downlink control channel (PDCCH) signaling during a PDCCH monitoring occasion within the next active state. However, the UE is required to activate the main radio of the UE in order to monitor for the control messages, which increases the power consumption of the UE.

Another power-saving mechanism used by some wireless devices is low-power wake-up signals (LP-WUSs). The network may utilize LP-WUSs to indicate whether the network has data to deliver to the UE, and therefore indicate to the UE to monitor for PDCCH signaling in a PDCCH monitoring occasion. LP-WUSs utilize simpler waveforms as compared to the DCP messages used in the DRX context. As such, LP-WUSs can be received via a low-power wake-up receiver (LP-WUR) while the UE is in an inactive state, which is simpler and less power-intensive compared to the main radio, thereby reducing the power consumption at the UE. However, conventional wireless communications systems do not include any mechanisms for utilizing DRX configurations and LP-WUSs in conjunction with one another. Accordingly, aspects of the present disclosure are directed to techniques that utilize LP-WUSs for triggering PDCCH monitoring in the context of a DRX configuration, as well as for triggering PDCCH monitoring that is unrelated to the DRX configuration.

For example, a UE may be configured with a first set of LP-WUS monitoring occasions that are used to trigger PDCCH monitoring occasions associated with a DRX configuration (e.g., DRX-related LP-WUS monitoring occasions), and a second set of LP-WUS monitoring occasions that are used to trigger PDCCH monitoring occasions that are separate from the DRX configuration (e.g., non-DRX LP-WUS monitoring occasions). Within each monitoring occasion, the UE may monitor, search, or receive LP-WUSs within configured time and frequency resources. The UE may then be configured to monitor both sets of LP-WUS monitoring occasions, and trigger DRX-related or non-DRX-related PDCCH monitoring occasions based on whether an LP-WUS is received within the first set of LP-WUS monitoring occasions associated the DRX configuration or the second set of LP-WUS monitoring occasions that are separate from the DRX configuration.

Techniques described herein may enable the UE to be configured with multiple different sets of LP-WUS monitoring occasions, thereby providing more opportunities for the network to alert the UE of data traffic, and enabling the UE to trigger active periods more frequently. As such, techniques described herein may reduce a latency of downlink traffic from the network to the UE. Furthermore, by utilizing LP-WUSs to trigger PDCCH monitoring in the context of a DRX configuration, aspects of the present disclosure may enable the UE to perform LP-WUS monitoring using an LP-WUR that exhibits lower power consumption as compared to the main radio. Therefore, techniques described herein may further lower a power consumption at the UE associated with performing LP-WUS monitoring during inactive periods of a DRX cycle.

Aspects of the disclosure are initially described in the context of wireless communications systems. Additional aspects of the disclosure are described in the context of an example DRX configuration, an example LP-WUS triggered control channel monitoring configuration, and an example process flow. Aspects of the disclosure are further illustrated by and described with reference to apparatus diagrams, system diagrams, and flowcharts that relate to configuration, activation, and operation for low power-wake up signals.

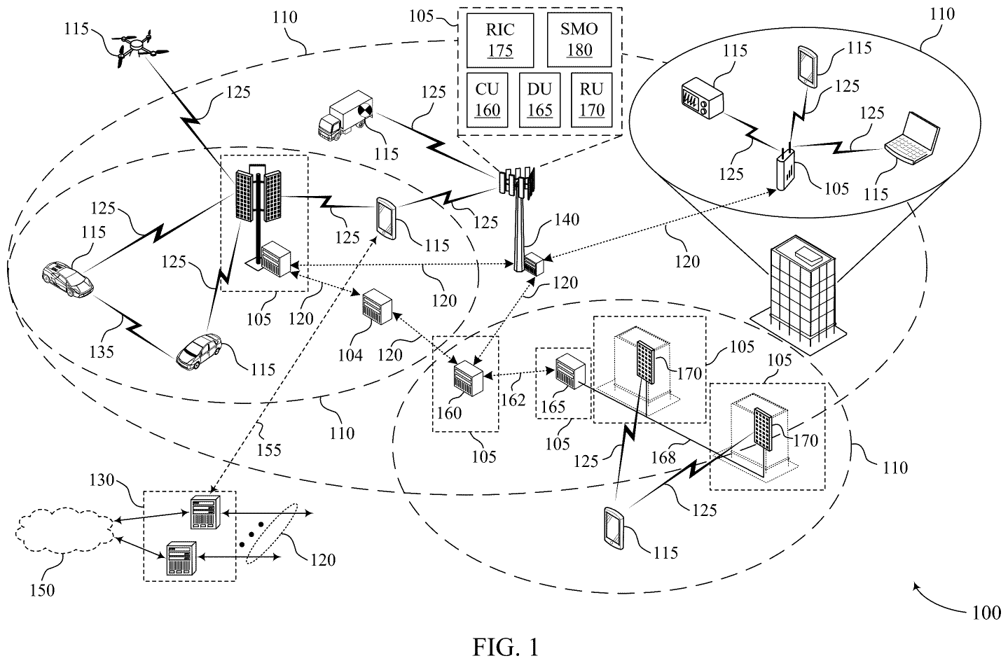

FIG. 1 shows an example of a wireless communications system 100 that supports configuration, activation, and operation for low power-wake up signals in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support configuration, activation, and operation for low power-wake up signals as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A UE 115 may be configured with a first set of LP-WUS monitoring occasions that are used to trigger PDCCH monitoring occasions associated with a DRX configuration (e.g., DRX-related LP-WUS monitoring occasions), and a second set of LP-WUS monitoring occasions that are used to trigger PDCCH monitoring occasions that are separate from the DRX configuration (e.g., non-DRX LP-WUS monitoring occasions). Within each monitoring occasion, the UE 115 may monitor, search, or receive LP-WUSs within configured time and frequency resources. The UE 115 may then be configured to monitor both sets of LP-WUS monitoring occasions, and trigger DRX-related or non-DRX-related PDCCH monitoring occasions based on whether an LP-WUS is received within the first set of LP-WUS monitoring occasions associated the DRX configuration or the second set of LP-WUS monitoring occasions that are separate from the DRX configuration.

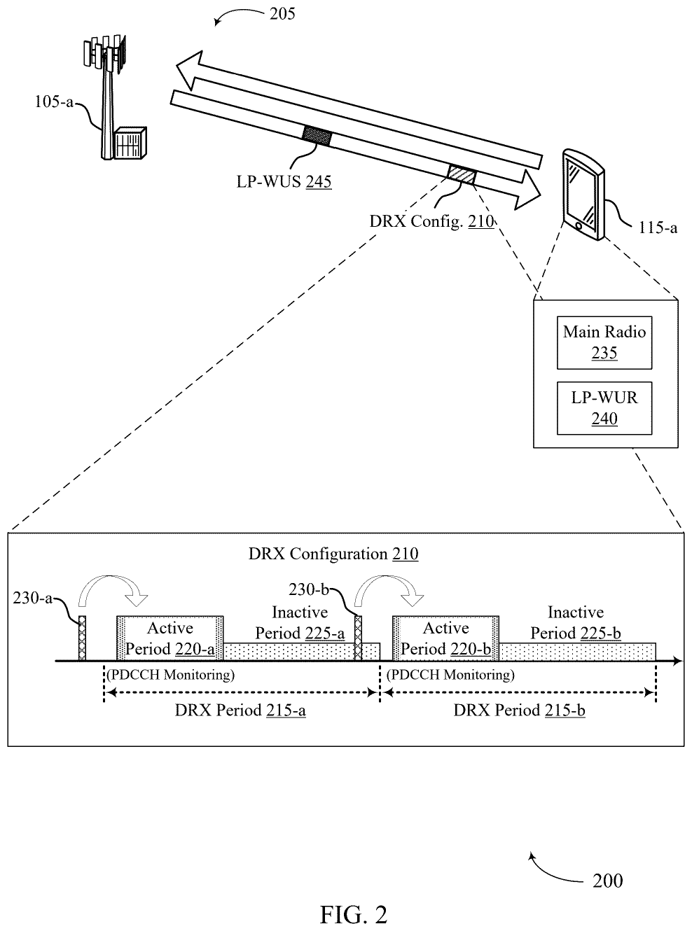

FIG. 2 shows an example of a wireless communications system 200 that supports configuration, activation, and operation for low power-wake up signals in accordance with one or more aspects of the present disclosure. In some examples, aspects of the wireless communications system 200 may implement, or be implemented by, aspects of the wireless communications system 100. The wireless communications system 200 may include a network entity 105-a and a UE 115-a, which may be examples of wireless devices as described herein. In some aspects, the network entity 105-a and the UE 115-a may communicate with one another using a communication link 205, which may be an example of an NR or LTE link, sidelink (e.g., PC5 link), and the like, between the respective devices.

In some wireless communications systems, wireless devices (e.g., UEs 115) may utilize different mechanisms for reducing power consumption. For example, UEs 115 may operate according to a DRX configuration, where the UE 115 transitions between “active states” (higher power consumption) and “inactive states” (lower power consumption). For instance, as shown in FIG. 2, the UE 115-a may be configured with a DRX configuration 210 that includes multiple repeating DRX periods 215-a, 215-b. Each DRX period 215 may include active period 220-a, 220-b, and inactive period 225-a, 225-b. In some cases, the active periods 220 of the DRX configuration may additionally, or alternatively, be referred to as downlink control channel monitoring occasions, or PDCCH monitoring occasions.

Connected-mode DRX (C-DRX) is a UE power saving procedure in which UE 115-a periodically wakes up to monitor PDCCH for control messages from network entity 105-a. For instance, as shown in the DRX configuration 210, the UE 115-a may be expected to periodically wake up to monitor for PDCCH messages during designated monitoring occasions 230-a, 230-b. The network may use such PDCCH messages within the monitoring occasions 230-a, 230-b to indicate whether the network has data to deliver to the UE 115-a. As such, the network may use the monitoring occasions 230 to trigger the UE 115-a to “wake up” in subsequent active periods 220-a, 220-b (e.g., wake up for PDCCH monitoring occasions) so that the UE 115-a can receive data from the network. In the context of C-DRX, when the UE 115 is not monitoring for PDCCH, the UE 115 is allowed to go into a sleep state (e.g., low-power state, inactive period 225).

A disadvantage of C-DRX is that the periodicity of PDCCH monitoring may be fixed once configured. That is, the periodicity of the PDCCH monitoring occasions 230 for receiving the PDCCH messages may be fixed once the UE 115-a is configured with the DRX configuration 210. As such, the UE 115 may be expected to wake up and monitor for PDCCH during every PDCCH monitoring occasion 230 and/or during every “on duration” (e.g., active period 220, PDCCH monitoring occasion) even when the network has no data to transmit to UE 115. Additionally, in the context of C-DRX, the network may utilize PDCCH messages during the monitoring occasions 230-a, 230-b to trigger the active periods 220 (e.g., trigger PDCCH monitoring occasions) of the DRX periods 215. Such PDCCH messages may include complex waveforms that must be received and processed by a main radio 235 at the UE 115-a. That is, the UE 115-a may be required to turn on the main radio 235 for every monitoring occasion 230 (and during every active period 220/PDCCH monitoring occasion), which further increases the energy consumption at the UE 115-a. These disadvantages limit the power saving gains and latency performance of conventional C-DRX configurations.

Some wireless communications systems may implement LP-WUSs 245 as another power-saving mechanism at the UE 115-a. in order to reduce power consumption associated with the DRX configuration 210, the network entity 105-a may utilize LP-WUSs 245 during the monitoring occasions 230 in order to trigger active periods 220 (e.g., PDCCH monitoring occasions) of the DRX configuration. For LP-WUS 245 triggered PDCCH monitoring, the UE 115-a may be equipped with a LP-WUR 240, which may exhibit lower complexity and lower power consumption as compared to the main radio 235. The main radio 235 may be able to receive and process complex waveforms, but may take longer wait times to turn on and off. Comparatively, the LP-WUR 240 may be capable of receiving and processing simple signals (e.g., on-off keying (OOK) waveform), but may be switched on and off quickly. As such, the LP-WUR 240 may use significantly less power to operate as compared to the main radio 235.

In accordance with aspects of the present disclosure, the UE 115-a may be configured (by the network, such as via RRC signaling) with one or more configurations that are associated with the DRX configuration 210, and one or more configurations that are separate/independent from (e.g., not associated with) the DRX configuration 210. In this regard, a configuration of the one or more configurations with a first set of LP-WUS monitoring occasions 230 associated with the DRX configuration 210 (e.g., DRX-related LP-WUS monitoring occasions) may be usable for triggering active periods 220 (e.g., PDCCH monitoring occasions) associated with the DRX configuration 210. Comparatively, a configuration of the one or more configurations with a second set of LP-WUS monitoring occasions 230 that are not associated with the DRX configuration 210 (e.g., non-DRX LP-WUS monitoring occasions) may be usable for triggering active periods 220 (e.g., PDCCH monitoring occasions) that are separate/independent from (e.g., not associated with) the DRX configuration 210. In some cases, the first and second sets of LP-WUS monitoring occasions 230 may be associated with different periodicities.

In order to combine DRX configurations (e.g., C-DRX) and LP-WUS-triggered PDCCH monitoring, aspects of the present disclosure are directed to signaling and configurations for replacing DCP messages (e.g., DCP messages 310) with LP-WUS messages, and for configuring additional LP-WUS monitoring occasions that are not associated with (e.g., separate/independent from) DRX configurations 210.

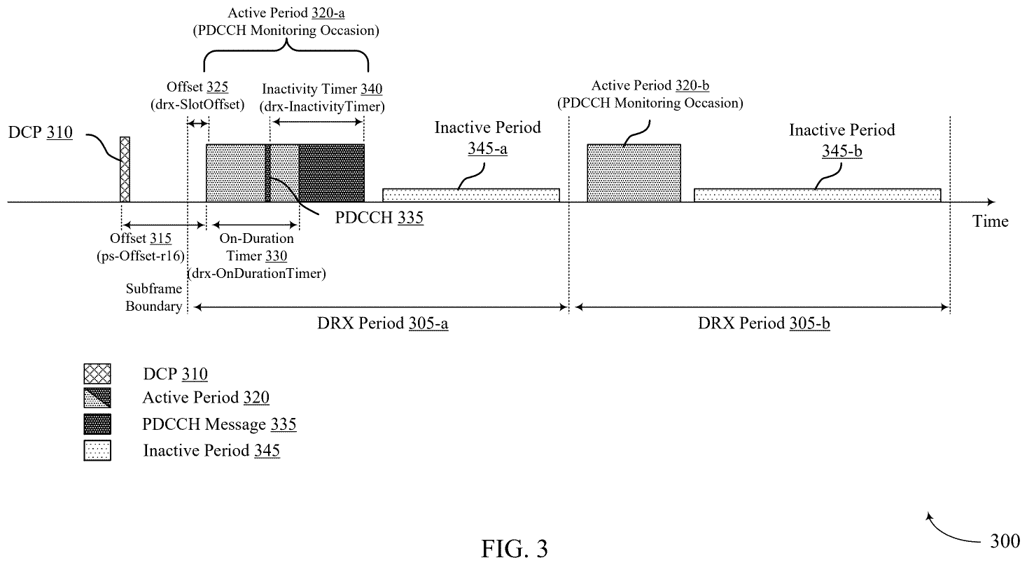

FIG. 3 shows an example of a DRX configuration 300 (e.g., C-DRX configuration) that supports configuration, activation, and operation for low power-wake up signals in accordance with one or more aspects of the present disclosure. In some examples, aspects of the DRX configuration 300 may implement, or be implemented by, aspects of the wireless communications system 100, the wireless communications system 200, or both.

As shown in FIG. 3, the DRX configuration 300 may include multiple repeating DRX periods 305-a, 305-b. Each DRX period 305 may include an active period 320-a, 320-b (e.g., PDCCH monitoring occasion) and an inactive period 345-a, 345-b. A UE 115 configured with the DRX configuration 300 may be configured to monitor for control signal in PDCCH from the serving cell during the respective active periods 320-a, 320-b. The active periods 320 (e.g., “active time,” PDCCH monitoring occasions) may include time periods where an on-duration timer 330 (e.g., drx-OnDurationTimer) and/or an inactivity timer 340 (e.g., drx-InactivityTimer) configured for the DRX configuration 300 or DRX group is running.

For example, the UE 115 may start the on-duration timer 330 to begin an active period 320-a (e.g., PDCCH monitoring occasion) for a DRX period 305. If the UE 115 receives a PDCCH message 335 during the active period 320-a (e.g., while the on-duration timer 330 is running), the UE 115 may start the inactivity timer 340 in order to extend the active period 320-a (e.g., PDCCH monitoring occasion) to perform some communication scheduled by the PDCCH message 335. That is, if the UE 115 receives a PDCCH message 335 that indicates a new transmission (e.g., downlink, uplink, and/or sidelink message) on a serving cell of the DRX group, the UE 115 may be configured to start or restart the drx-InactivityTimer (e.g., inactivity timer 340) in order to extend the active period 320-a so that the UE 115 can perform the scheduled communication.

In some aspects, the starting subframe of a DRX cycle (e.g., DRX configuration 300) may be determined based on a configuration parameter drx-LongCycleStartOffset. Such DRX configuration parameters may be configured via control signaling (e.g., RRC signaling) from the network.

In some aspects, according to a conventional C-DRX configuration (e.g., DRX configuration 300), the UE 115 may be configured to monitor for DCP messages 310 that are used to trigger the UE 115 to perform PDCCH monitoring during a subsequent active period 320 (e.g., subsequent PDCCH monitoring occasion). A UE 115 may be configured to initiate an active period 320-a some time duration (defined by offset 315) after receiving the DCP message 310. The active period 320-a of the DRX cycle may start at the beginning of a subframe or slot, as defined by an offset 325 (e.g., drx-SlotOffset). That is, the UE 115 may initiate the on-duration timer 330 (e.g., drx-OnDurationTimer) some offset 315 after receiving the DCP message 310, and/or some offset 325 following a slot/subframe boundary that follows reception of the DCP message 310.

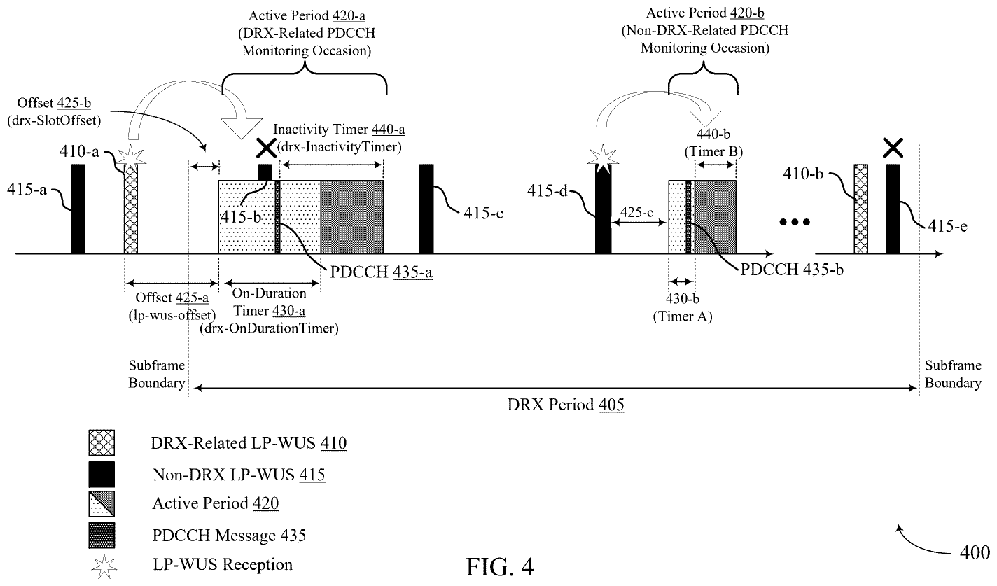

FIG. 4 shows an example of a monitoring configuration 400 that supports configuration, activation, and operation for low power-wake up signals in accordance with one or more aspects of the present disclosure. In some examples, aspects of the monitoring configuration 400 may implement, or be implemented by, aspects of the wireless communications system 100, the wireless communications system 200, the DRX configuration 300, or any combination thereof. In particular, the monitoring configuration 400 illustrates techniques for combining a C-DRX configuration with LP-WUS-triggered PDCCH monitoring, according to aspects of the present disclosure.

As noted previously herein, in some aspects, a UE 115 may be configured with one or more DRX configurations (e.g., C-DRX configuration), each configuration including multiple repeating DRX periods (e.g., DRX period 405). In accordance with some aspects of the present disclosure, a UE 115 may be configured with a first set of LP-WUS monitoring occasions 410 associated with the DRX configuration. For example, as shown in FIG. 4, the UE 115 may be configured with a first set of LP-WUS monitoring occasions (e.g., including at least an LP-WUS monitoring occasion 410-a and an LP-WUS monitoring occasion 410-b) associated with the DRX configuration, where the first set of LP-WUS monitoring occasions 410 are usable for triggering a first set of PDCCH monitoring occasions of the DRX configuration. For example, the LP-WUS monitoring occasion 410-a may be usable for triggering a first DRX-related PDCCH monitoring occasion (e.g., first active period 420-a). In some examples, the LP-WUS monitoring occasion 410-b may be usable for triggering a DRX-related PDCCH monitoring occasion in a DRX period immediately after DRX period 405.

Additionally, in some aspects, the UE 115 may receive one or more configurations, each configuration associated with a second set of LP-WUS monitoring occasions 415 that are not associated with the DRX configuration (e.g., second set of LP-WUS monitoring occasions 415 that are independent from the DRX configuration). For example, as shown in FIG. 4, the UE 115 may be configured with a second set of LP-WUS monitoring occasions 415 (e.g., including at least an LP-WUS monitoring occasion 415-a, 415-b, 415-c, 415-d, and 415-e) that are not associated with (e.g., separate or independent from) the DRX configuration, where the second set of LP-WUS monitoring occasions 415 are usable for triggering a second set of PDCCH monitoring occasions that are separate/independent from the DRX configuration. For example, as shown in FIG. 4, the LP-WUS monitoring occasion 415-d may be usable for triggering a non-DRX related PDCCH monitoring occasion (e.g., active period 420-b) that is separate/independent from the PDCCH monitoring occasion (e.g., active period 420-a) of the DRX configuration. The second set of LP-WUS monitoring occasions 415, together with the first set of LP-WUS monitoring occasions 410, may enable the UE 115 to have more than one active period or more than one PDCCH monitoring occasion within a time window whose duration is equal to DRX period 405.

Configuring the UE 115 with C-DRX and non-C-DRX configurations with each configuration associated with respective sets of LP-WUS monitoring occasions may provide more opportunities for the network to inform the UE 115 of data traffic to be communicated to the UE 115, thereby reducing a latency of the data traffic. In particular, the first set of LP-WUS monitoring occasions 410 may be associated with a different periodicity as compared to the second set of LP-WUS monitoring occasions 415. For example, as shown in FIG. 4, the first set of LP-WUS monitoring occasions 410 may be associated with a first periodicity such that there is one LP-WUS monitoring occasion 410 from the first set of LP-WUS monitoring occasions 410 within or for each DRX period 405. Comparatively, the second set of LP-WUS monitoring occasions 415 may be associated with a second periodicity such that there are multiple LP-WUS monitoring occasions 415 from the second set of LP-WUS monitoring occasions 415 within or for each DRX period 405. In this regard, the second set of LP-WUS monitoring occasions 415 may provide additional opportunities within each DRX period 405 for the network to inform the UE 115 of data traffic that is to be delivered to the UE 115.

The periodicity of the first set of LP-WUS monitoring occasions 410 and the second set of LP-WUS monitoring occasions 415 for triggering PDCCH monitoring occasions may determine a relative timing of the PDCCH monitoring occasion (e.g., active periods 420) triggered by LP-WUS received in the respective LP-WUS monitoring occasion. For example, as shown in FIG. 4, each LP-WUS monitoring occasion from the first set of LP-WUS monitoring occasions 410 may be usable for triggering an active period 420 (e.g., DRX-related PDCCH monitoring occasion) in a corresponding DRX cycle/period. For instance, reception of an LP-WUS via the LP-WUS monitoring occasion 410-a may be used to trigger a DRX-related PDCCH monitoring occasion (e.g., active period 420-b) in the DRX period 405. Similarly, reception of an LP-WUS via the LP-WUS monitoring occasion 410-b may be used to trigger a DRX-related PDCCH monitoring occasion in a corresponding DRX cycle/period that is immediately after DRX period 405.

Comparatively, at least some of the second set of LP-WUS monitoring occasions 415 may be usable for triggering non-DRX related PDCCH monitoring occasions in the same DRX period as the respective LP-WUS monitoring occasion. For instance, as shown in FIG. 4, reception of an LP-WUS via the LP-WUS monitoring occasion 415-d may be used to trigger an additional active period 420-b (e.g., non-DRX related PDCCH monitoring occasion) in the DRX period 405. As such, configuring the UE 115 with both sets of LP-WUS monitoring occasions 410, 415 may enable benefits of both respective designs.

In some aspects, the first set of LP-WUS monitoring occasions 410 associated with the DRX configuration and the second set of LP-WUS monitoring occasions 415 that are separate/independent from the DRX configuration may be associated with different timers for activating/implementing the respective active periods 420/PDCCH monitoring occasions.

For example, upon receiving a LP-WUS via the LP-WUS monitoring occasion 410-a from the first set of LP-WUS monitoring occasions 410, the UE 115 may be configured to start an active period 420-a (e.g., DRX-related PDCCH monitoring occasion) following an offset 425-a (e.g., lp-wus-Offset). In some aspects, the offset 425-a (e.g., lp-wus-Offset) may be greater than the wake up time for the main radio 235 (e.g., offset 425-a provides sufficient time for the UE 115 to activate/wake up the main radio 235 prior to the active period 420-a/PDCCH monitoring occasion). In some cases, the active period 420-a/DRX-related PDCCH monitoring occasion may start some offset 425-b (e.g., drx-SlotOffset) following the slot/subframe boundary separating the LP-WUS monitoring occasion 410-a and the active period 420-a.

The UE 115 may activate/start an on-duration timer 430-a (e.g., drx-OnDurationTimer) for the active period 420-a. The UE 115 may be configured to monitor for PDCCH messages 435-a using the main radio 235 for a duration of the on-duration timer 430-a (e.g., while drx-OnDurationTimer is running). If the UE 115 receives a PDCCH message 435-a during the active period 420-a, the UE 115 may activate/start an inactivity timer 440-a (e.g., drx-InactivityTimer) to extend the active period 420-a (e.g., extend the DRX-related PDCCH monitoring occasion). For example, the PDCCH message 435-a may schedule another communication to be performed by the UE 115, and the UE 115 may extend the active period 420-a by activating the inactivity timer 440-a in order to perform the scheduled communication within the active period 420-a.

Referring now to the second set of LP-WUS monitoring occasions 415, the second set of LP-WUS monitoring occasions 415 may be associated with a different periodicity and different set of offsets/timers as compared to the first set of LP-monitoring occasions 410. For example, upon receiving an LP-WUS via the LP-WUS monitoring occasion 415-d, the UE 115 may be configured to start an active period 420-b some offset 425-c after receiving the LP-WUS via the LP-WUS monitoring occasion 415-d, where the offset 425-c may be the same or different as compared to the offset 425-a. As noted previously herein, the offset 425-c may be based on (e.g., greater than) the time used to wake up or activate the main radio 235 of the UE 115. Further, the UE 115 may activate/start an on-duration timer 430-b (e.g., Timer A) for the active period 420-b (e.g., non-DRX related PDCCH monitoring occasion). That is, Timer A (which may be the same or different duration as compared to drx-OnDurationTimer) may be triggered by reception of the LP-WUS via the LP-WUS monitoring occasion 415-d, and may be started some time duration (defined by offset 425-c) after LP-WUS reception.

The UE 115 may be configured to monitor for PDCCH messages 435-b using the main radio 235 for a duration of the on-duration timer 430-b (e.g., while Timer A is running). If the UE 115 receives a PDCCH message 435-b during the active period 420-b, the UE 115 may activate/start an inactivity timer 440-b (e.g., Timer B) to extend the active period 420-b (e.g., extend the non-DRX-related PDCCH monitoring occasion). For example, the PDCCH message 435-b may schedule another communication to be performed by the UE 115, and the UE 115 may extend the active period 420-b by activating the inactivity timer 440-b in order to perform the scheduled communication within the active period 420-b. Timer B may be the same or different duration as the drx-InactivityTimer.

In some aspects, the one or more configurations associated with LP-WUS-triggered monitoring of C-DRX downlink control resources and/or the one or more configurations associated with LP-WUS-triggered monitoring of non-C-DRX downlink control resources may be activated via a medium access control-control element (MAC-CE). In some examples, a configuration activated by a MAC-CE may be activated or deactivated by a subsequent MAC-CE. In some examples, a UE 115 may transmit a request to activate or deactivate any configuration associated with C-DRX or non-C-DRX configurations. The request to activate or deactivate may be based on a capability of the UE. The request to activate or deactivate may be transmitted in a scheduling request.

In some aspects, an LP-WUS may include a command to skip LP-WUS monitoring occasions for a period of time or a quantity of LP-WUS monitoring occasions, a command to change a periodicity or an offset of the LP-WUS monitoring occasions, a command to modify configurations associated with subsequent LP-WUS monitoring occasions, an indication of a PDCCH monitoring delay, or combinations thereof.

In some aspects, a quantity of configurations associated with LP-WUS-triggered monitoring of C-DRX downlink control resources and/or a quantity associated with the one or more configurations associated with LP-WUS-triggered monitoring of non-C-DRX downlink control resources may be based on a capability of the UE.

In some aspects, upon receiving an LP-WUS during an active DRX cycle or during a PDCCH monitoring occasion, a UE 115 may choose to extend a time period associated with the active DRX cycle, extend a time period associated with the PDCCH monitoring occasion, stop all DRX timers associated with the active DRX cycle, or stop all PDCCH monitoring occasions

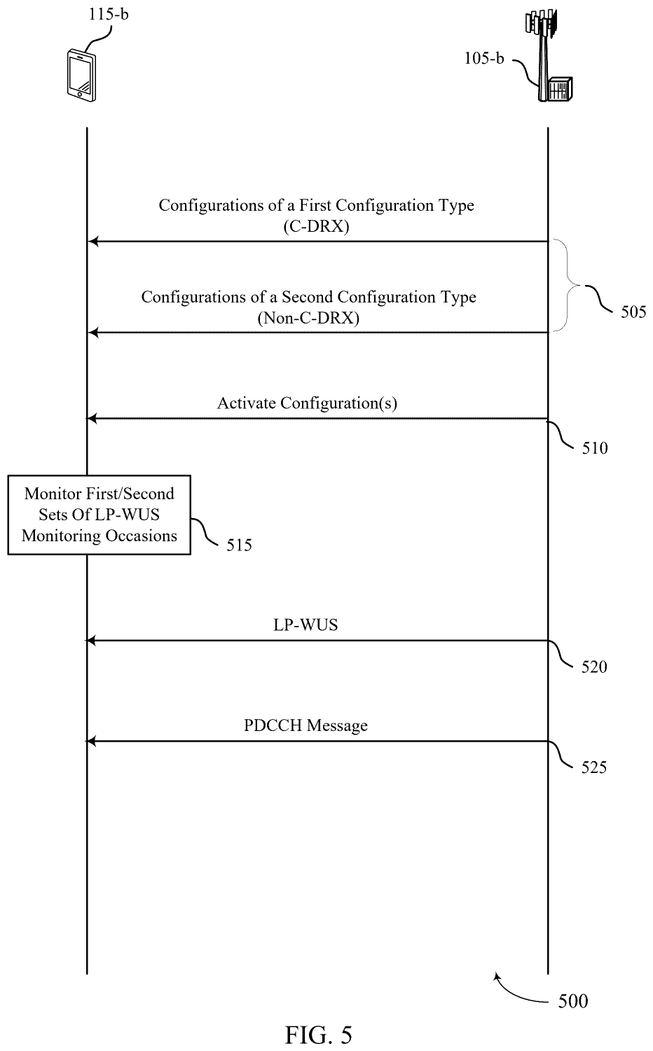

FIG. 5 shows an example of a process flow 500 that supports configuration, activation, and operation for low power-wake up signals in accordance with one or more aspects of the present disclosure. In some examples, aspects of the process flow 500 may implement, or be implemented by, aspects of the wireless communications system 100, the wireless communications system 200, the DRX configuration 300, the monitoring configuration 400, or any combination thereof. The process flow 500 includes a network entity 105-b and a UE 115-b, which may be examples of wireless devices as described herein. For example, the network entity 105-b and the UE 115-b illustrated in FIG. 5 may include examples of the network entity 105-a and the UE 115-a, respectively, as illustrated in FIG. 2.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-b may receive control signaling (e.g., RRC signaling) indicating one or more configurations of a first LP-WUS configuration type associated with LP-WUS-triggered monitoring of C-DRX downlink control resources, and/or one or more configurations of a second LP-WUS configuration type associated with LP-WUS-triggered monitoring of non-C-DRX downlink control resources. In some aspects, respective parameters (offset, periodicity) of the first and second configuration types may be the same or different.

At 510, the UE 115-b may receive an activation command to activate one or more respective configurations for the first LP-WUS configuration type and the second LP-WUS configuration type. In some examples, the activation command is a MAC-CE.

At 515, the UE 115-b may monitor a first set of LP-WUS monitoring occasions and/or a second set of LP-WUS monitoring occasions in accordance with the first LP-WUS configuration type and the second LP-WUS configuration type. At 520, the UE 115-b may receive a LP-WUS via the first set of LP-WUS monitoring occasions and/or a second set of LP-WUS monitoring occasions. The UE 115-b may monitor for PDCCH signaling from the network entity 105-b within the activated PDCCH monitoring occasion (e.g., active period 420).

At 525, the UE 115-b may receive a PDCCH message from the network entity 105-b via a PDCCH monitoring occasion indicated by the LP-WUS of 520.

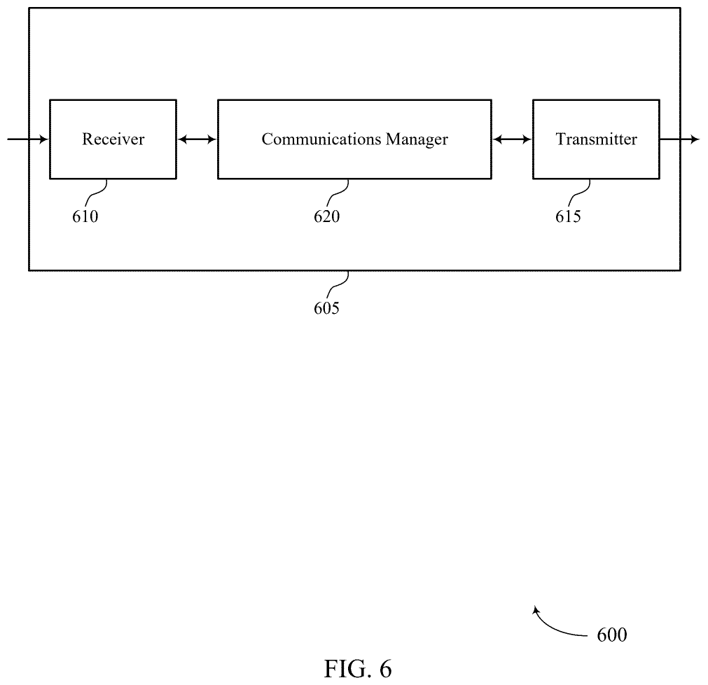

FIG. 6 shows a block diagram 600 of a device 605 that supports configuration, activation, and operation for low power-wake up signals in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to configuration, activation, and operation for low power-wake up signals). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuration, activation, and operation for low power-wake up signals). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of configuration, activation, and operation for low power-wake up signals as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources. The communications manager 620 is capable of, configured to, or operable to support a means for receiving an activation command that activates monitoring of LP-WUS monitoring occasions according to a first configuration of the one or more configurations of the first LP-WUS configuration type, a second configuration of the one or more configurations of the second LP-WUS configuration type, or both. The communications manager 620 is capable of, configured to, or operable to support a means for receiving a PDCCH during a PDCCH monitoring occasion in accordance with the first configuration, the second configuration, or both.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for configuration, activation, and operation for low power-wake up signals which may reduce latency and power usage.

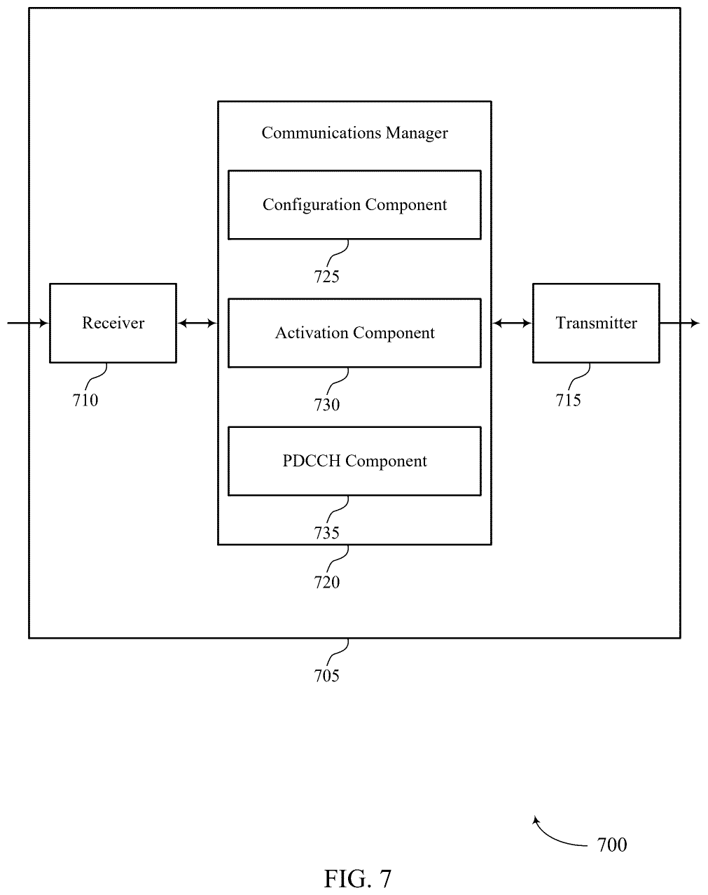

FIG. 7 shows a block diagram 700 of a device 705 that supports configuration, activation, and operation for low power-wake up signals in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to configuration, activation, and operation for low power-wake up signals). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configuration, activation, and operation for low power-wake up signals). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of configuration, activation, and operation for low power-wake up signals as described herein. For example, the communications manager 720 may include a configuration component 725, an activation component 730, a PDCCH component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for receiving one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources. The activation component 730 is capable of, configured to, or operable to support a means for receiving an activation command that activates monitoring of LP-WUS monitoring occasions according to a first configuration of the one or more configurations of the first LP-WUS configuration type, a second configuration of the one or more configurations of the second LP-WUS configuration type, or both. The PDCCH component 735 is capable of, configured to, or operable to support a means for receiving a PDCCH during a PDCCH monitoring occasion in accordance with the first configuration, the second configuration, or both.

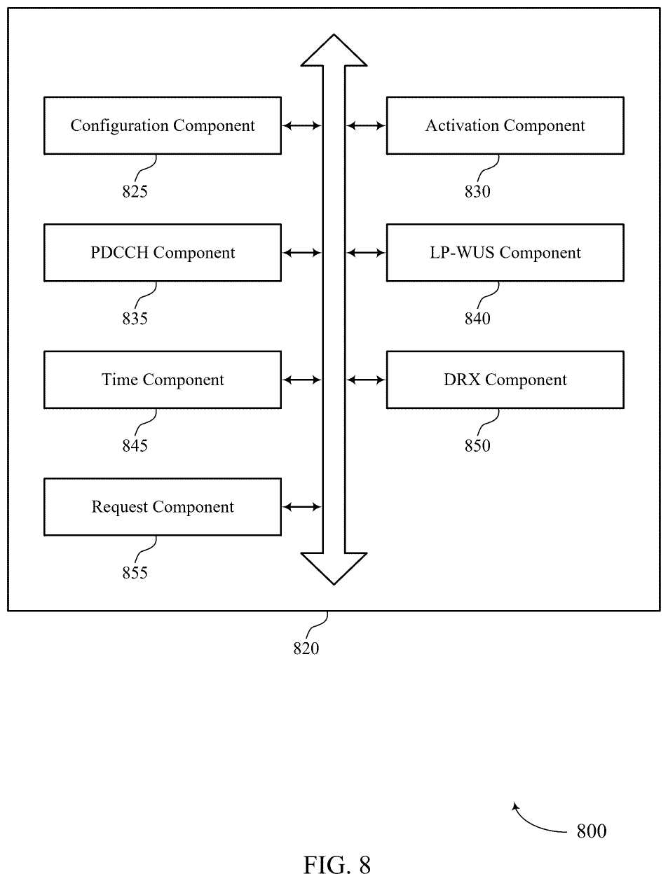

FIG. 8 shows a block diagram 800 of a communications manager 820 that supports configuration, activation, and operation for low power-wake up signals in accordance with one or more aspects of the present disclosure. The communications manager 820 may be an example of aspects of a communications manager 620, a communications manager 720, or both, as described herein. The communications manager 820, or various components thereof, may be an example of means for performing various aspects of configuration, activation, and operation for low power-wake up signals as described herein. For example, the communications manager 820 may include a configuration component 825, an activation component 830, a PDCCH component 835, an LP-WUS component 840, a time component 845, a DRX component 850, a request component 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for receiving one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources. The activation component 830 is capable of, configured to, or operable to support a means for receiving an activation command that activates monitoring of LP-WUS monitoring occasions according to a first configuration of the one or more configurations of the first LP-WUS configuration type, a second configuration of the one or more configurations of the second LP-WUS configuration type, or both. The PDCCH component 835 is capable of, configured to, or operable to support a means for receiving a PDCCH during a PDCCH monitoring occasion in accordance with the first configuration, the second configuration, or both.

In some examples, the configuration component 825 is capable of, configured to, or operable to support a means for receiving both the one or more configurations of the first LP-WUS configuration type and the one or more configurations of the second LP-WUS configuration type.

In some examples, the LP-WUS component 840 is capable of, configured to, or operable to support a means for receiving an LP-WUS during the LP-WUS monitoring occasions in accordance with the first configuration, the second configuration, or both, where the LP-WUS triggers the PDCCH monitoring occasion during a time period based on an LP-WUS offset.

In some examples, the time component 845 is capable of, configured to, or operable to support a means for extending a time period associated with the active DRX cycle. In some examples, the time component 845 is capable of, configured to, or operable to support a means for extending a time period associated with the PDCCH monitoring occasion. In some examples, the DRX component 850 is capable of, configured to, or operable to support a means for stopping all DRX timers associated with the active DRX cycle. In some examples, the PDCCH component 835 is capable of, configured to, or operable to support a means for stopping all PDCCH monitoring occasions.

In some examples, the activation command includes a command to skip LP-WUS monitoring occasions for a period of time or a quantity of LP-WUS monitoring occasions, a command to change a periodicity or an offset of the LP-WUS monitoring occasions, a command to modify configurations associated with subsequent LP-WUS monitoring occasions, an indication of a PDCCH monitoring delay, or combinations thereof.

In some examples, the activation component 830 is capable of, configured to, or operable to support a means for receiving a second activation command, where a configuration activated by the activation command remains active or is deactivated based on the second activation command.

In some examples, the activation component 830 is capable of, configured to, or operable to support a means for transmitting a request to activate or deactivate the one or more configurations of the first LP-WUS configuration type or the one or more configurations of the second LP-WUS configuration type.

In some examples, the request to activate or deactivate is based on a capability of the UE.

In some examples, the request component 855 is capable of, configured to, or operable to support a means for transmitting a scheduling request, where the scheduling request includes the request to activate or deactivate.

In some examples, a medium access control-control element includes the activation command.

In some examples, the one or more parameters associated with the first LP-WUS configuration type and the one or more parameters associated with the second LP-WUS configuration type include a periodicity and an offset of LP-WUS monitoring resources.

In some examples, a quantity of the one or more configurations of the first LP-WUS configuration type and a quantity of the one or more configurations of the second LP-WUS configuration type is based on a capability of the UE.

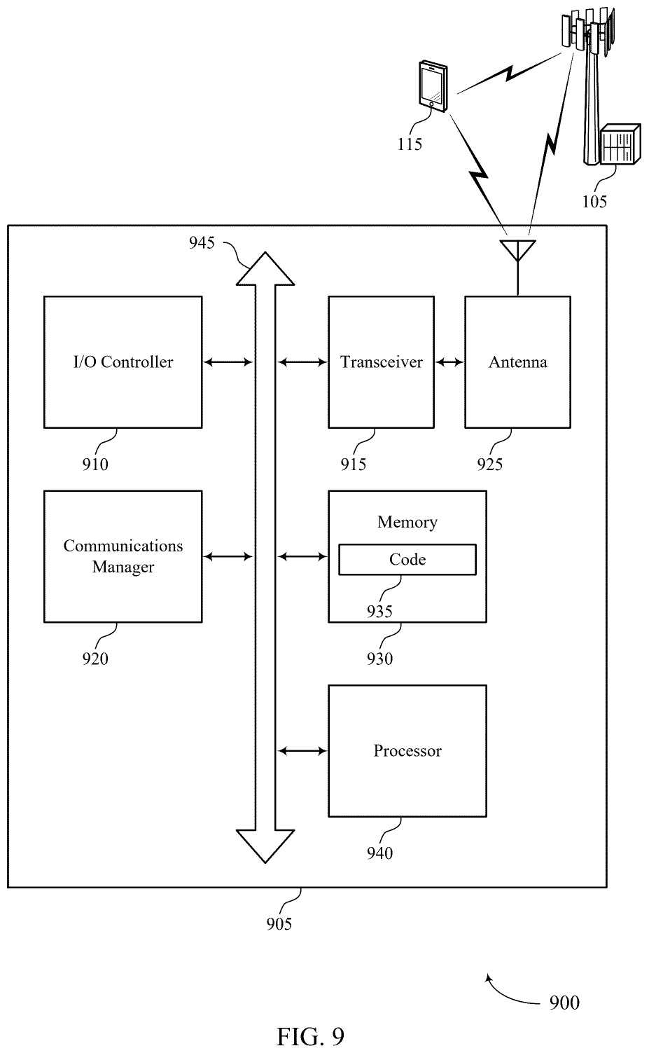

FIG. 9 shows a diagram of a system 900 including a device 905 that supports configuration, activation, and operation for low power-wake up signals in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting configuration, activation, and operation for low power-wake up signals). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources. The communications manager 920 is capable of, configured to, or operable to support a means for receiving an activation command that activates monitoring of LP-WUS monitoring occasions according to a first configuration of the one or more configurations of the first LP-WUS configuration type, a second configuration of the one or more configurations of the second LP-WUS configuration type, or both. The communications manager 920 is capable of, configured to, or operable to support a means for receiving a PDCCH during a PDCCH monitoring occasion in accordance with the first configuration, the second configuration, or both.

By including or configuring the communications manager 920 in accordance with examples as described herein, the device 905 may support techniques for configuration, activation, and operation for low power-wake up signals which may reduce latency and power usage.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of configuration, activation, and operation for low power-wake up signals as described herein, or the at least one processor 940 and the at least one memory 930 may be otherwise configured to, individually or collectively, perform or support such operations.

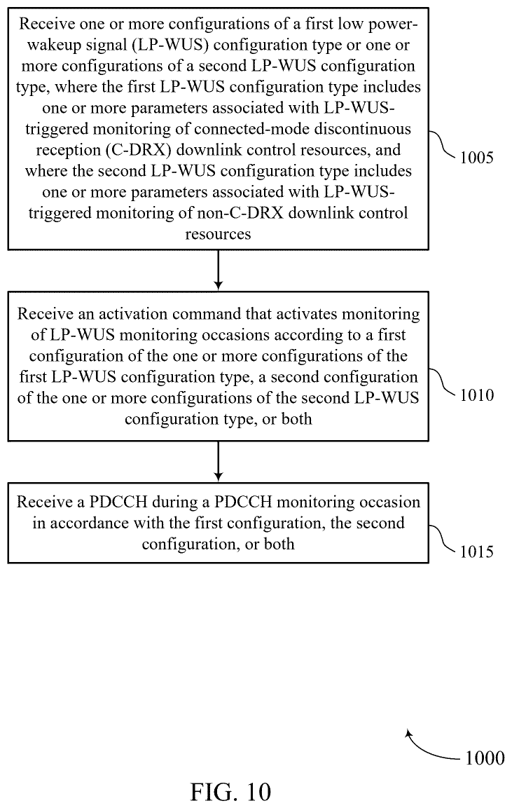

FIG. 10 shows a flowchart illustrating a method 1000 that supports configuration, activation, and operation for low power-wake up signals in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving one or more configurations of a first LP-WUS configuration type or one or more configurations of a second LP-WUS configuration type, where the first LP-WUS configuration type includes one or more parameters associated with LP-WUS-triggered monitoring of C-DRX downlink control resources, and where the second LP-WUS configuration type includes one or more parameters associated with LP-WUS-triggered monitoring of non-C-DRX downlink control resources. The operations of 1005 may be performed in accordance with examples as disclosed herein. In some examples, aspects of the operations of 1005 may be performed by a configuration component 825 as described with reference to FIG. 8.

At 1010, the method may include receiving an activation command that activates monitoring of LP-WUS monitoring occasions according to a first configuration of the one or more configurations of the first LP-WUS configuration type, a second configuration of the one or more configurations of the second LP-WUS configuration type, or both. The operations of 1010 may be performed in accordance with examples as disclosed herein. In some examples, aspects of the operations of 1010 may be performed by an activation component 830 as described with reference to FIG. 8.

At 1015, the method may include receiving a PDCCH during a PDCCH monitoring occasion in accordance with the first configuration, the second configuration, or both. The operations of 1015 may be performed in accordance with examples as disclosed herein. In some examples, aspects of the operations of 1015 may be performed by a PDCCH component 835 as described with reference to FIG. 8.

The following provides an overview of aspects of the present disclosure:

Aspect 1: A method for wireless communications by a UE, comprising: receiving one or more configurations of a first LP-WUS configuration type or one or more configurations of a second LP-WUS configuration type, wherein the first LP-WUS configuration type comprises one or more parameters associated with LP-WUS-triggered monitoring of C-DRX downlink control resources, and wherein the second LP-WUS configuration type comprises one or more parameters associated with LP-WUS-triggered monitoring of non-C-DRX downlink control resources; receiving an activation command that activates monitoring of LP-WUS monitoring occasions according to a first configuration of the one or more configurations of the first LP-WUS configuration type, a second configuration of the one or more configurations of the second LP-WUS configuration type, or both; and receiving a PDCCH during a PDCCH monitoring occasion in accordance with the first configuration, the second configuration, or both.

Aspect 2: The method of aspect 1, further comprising: receiving both the one or more configurations of the first LP-WUS configuration type and the one or more configurations of the second LP-WUS configuration type.

Aspect 3: The method of any of aspects 1 through 2, further comprising: receiving an LP-WUS during the LP-WUS monitoring occasions in accordance with the first configuration, the second configuration, or both, wherein the LP-WUS triggers the PDCCH monitoring occasion during a time period based at least in part on an LP-WUS offset.

Aspect 4: The method of aspect 3, wherein upon receiving the LP-WUS during an active DRX cycle or during a PDCCH monitoring occasion, the method further comprises: extending a time period associated with the active DRX cycle; extending a time period associated with the PDCCH monitoring occasion; stopping all DRX timers associated with the active DRX cycle; or stopping all PDCCH monitoring occasions.

Aspect 5: The method of any of aspects 1 through 4, wherein the activation command comprises a command to skip LP-WUS monitoring occasions for a period of time or a quantity of LP-WUS monitoring occasions, a command to change a periodicity or an offset of the LP-WUS monitoring occasions, a command to modify configurations associated with subsequent LP-WUS monitoring occasions, an indication of a PDCCH monitoring delay, or combinations thereof.

Aspect 6: The method of any of aspects 1 through 5, further comprising: receiving a second activation command, wherein a configuration activated by the activation command remains active or is deactivated based at least in part on the second activation command.

Aspect 7: The method of any of aspects 1 through 6, further comprising: transmitting a request to activate or deactivate the one or more configurations of the first LP-WUS configuration type or the one or more configurations of the second LP-WUS configuration type.

Aspect 8: The method of aspect 7, wherein the request to activate or deactivate is based at least in part on a capability of the UE.

Aspect 9: The method of any of aspects 7 through 8, further comprising: transmitting a scheduling request, wherein the scheduling request comprises the request to activate or deactivate.

Aspect 10: The method of any of aspects 1 through 9, wherein a medium access control-control element comprises the activation command.

Aspect 11: The method of any of aspects 1 through 10, wherein the one or more parameters associated with the first LP-WUS configuration type and the one or more parameters associated with the second LP-WUS configuration type comprise a periodicity and an offset of LP-WUS monitoring resources.

Aspect 12: The method of any of aspects 1 through 11, wherein a quantity of the one or more configurations of the first LP-WUS configuration type and a quantity of the one or more configurations of the second LP-WUS configuration type is based at least in part on a capability of the UE.

Aspect 13: A UE for wireless communications, comprising one or more memories storing processor-executable code, and one or more processors coupled with the one or more memories and individually or collectively operable to execute the code to cause the UE to perform a method of any of aspects 1 through 12.

Aspect 14: A UE for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.”The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more configurations of a first low power-wakeup signal (LP-WUS) configuration type or one or more configurations of a second LP-WUS configuration type, wherein the first LP-WUS configuration type comprises one or more parameters associated with LP-WUS-triggered monitoring of connected-mode discontinuous reception (C-DRX) downlink control resources, and wherein the second LP-WUS configuration type comprises one or more parameters associated with LP-WUS-triggered monitoring of non-C-DRX downlink control resources;
receive an activation command that activates monitoring of LP-WUS monitoring occasions according to a first configuration of the one or more configurations of the first LP-WUS configuration type, a second configuration of the one or more configurations of the second LP-WUS configuration type, or both; and
receive a physical downlink control channel (PDCCH) during a PDCCH monitoring occasion in accordance with the first configuration, the second configuration, or both.

2. The UE of claim 1, wherein the activation command comprises a command to skip LP-WUS monitoring occasions for a period of time or a quantity of LP-WUS monitoring occasions, a command to change a periodicity or an offset of the LP-WUS monitoring occasions, a command to modify configurations associated with subsequent LP-WUS monitoring occasions, an indication of a PDCCH monitoring delay, or combinations thereof.

3. The UE of claim 1, wherein the one or more processors are individually or collectively further operable to execute the code to cause the UE to:
transmit a request to activate or deactivate the one or more configurations of the first LP-WUS configuration type or the one or more configurations of the second LP-WUS configuration type.

4. The UE of claim 3, wherein the request to activate or deactivate is based at least in part on a capability of the UE.

5. The UE of claim 3, wherein the one or more processors are individually or collectively further operable to execute the code to cause the UE to:
transmit a scheduling request, wherein the scheduling request comprises the request to activate or deactivate.

6. The UE of claim 1, wherein the one or more processors are individually or collectively further operable to execute the code to cause the UE to:
receive both the one or more configurations of the first LP-WUS configuration type and the one or more configurations of the second LP-WUS configuration type.

7. The UE of claim 1, wherein the one or more processors are individually or collectively further operable to execute the code to cause the UE to:
receive an LP-WUS during the LP-WUS monitoring occasions in accordance with the first configuration, the second configuration, or both, wherein the LP-WUS triggers the PDCCH monitoring occasion during a time period based at least in part on an LP-WUS offset.

8. The UE of claim 7, wherein upon receiving the LP-WUS during an active DRX cycle or during a PDCCH monitoring occasion, the one or more processors are individually or collectively further operable to execute the code to cause the UE to:
extend time period associated with the active DRX cycle;
extend a time period associated with the PDCCH monitoring occasion;
stop all DRX timers associated with the active DRX cycle; or
stop all PDCCH monitoring occasions.

9. The UE of claim 1, wherein the one or more processors are individually or collectively further operable to execute the code to cause the UE to:
receive a second activation command, wherein a configuration activated by the activation command remains active or is deactivated based at least in part on the second activation command.

10. The UE of claim 1, wherein a medium access control-control element comprises the activation command.

11. The UE of claim 1, wherein the one or more parameters associated with the first LP-WUS configuration type and the one or more parameters associated with the second LP-WUS configuration type comprise a periodicity and an offset of LP-WUS monitoring resources.

12. The UE of claim 1, wherein a quantity of the one or more configurations of the first LP-WUS configuration type and a quantity of the one or more configurations of the second LP-WUS configuration type is based at least in part on a capability of the UE.

13. A method for wireless communications by a user equipment (UE), comprising:
receiving one or more configurations of a first low power-wakeup signal (LP-WUS) configuration type or one or more configurations of a second LP-WUS configuration type, wherein the first LP-WUS configuration type comprises one or more parameters associated with LP-WUS-triggered monitoring of connected-mode discontinuous reception (C-DRX) downlink control resources, and wherein the second LP-WUS configuration type comprises one or more parameters associated with LP-WUS-triggered monitoring of non-C-DRX downlink control resources;
receiving an activation command that activates monitoring of LP-WUS monitoring occasions according to a first configuration of the one or more configurations of the first LP-WUS configuration type, a second configuration of the one or more configurations of the second LP-WUS configuration type, or both; and
receiving a physical downlink control channel (PDCCH) during a PDCCH monitoring occasion in accordance with the first configuration, the second configuration, or both.

14. The method of claim 13, wherein the activation command comprises a command to skip LP-WUS monitoring occasions for a period of time or a quantity of LP-WUS monitoring occasions, a command to change a periodicity or an offset of the LP-WUS monitoring occasions, a command to modify configurations associated with subsequent LP-WUS monitoring occasions, an indication of a PDCCH monitoring delay, or combinations thereof.

15. The method of claim 13, further comprising:
transmitting a request to activate or deactivate the one or more configurations of the first LP-WUS configuration type or the one or more configurations of the second LP-WUS configuration type.

16. The method of claim 15, wherein the request to activate or deactivate is based at least in part on a capability of the UE.

17. The method of claim 15, further comprising:
transmitting a scheduling request, wherein the scheduling request comprises the request to activate or deactivate.

18. The method of claim 13, further comprising:
receiving both the one or more configurations of the first LP-WUS configuration type and the one or more configurations of the second LP-WUS configuration type.

19. The method of claim 13, further comprising:
receiving an LP-WUS during the LP-WUS monitoring occasions in accordance with the first configuration, the second configuration, or both, wherein the LP-WUS triggers the PDCCH monitoring occasion during a time period based at least in part on an LP-WUS offset.

20. A non-transitory computer-readable medium storing code for wireless communications, the code comprising instructions executable by one or more processors to:
receive one or more configurations of a first low power-wakeup signal (LP-WUS) configuration type or one or more configurations of a second LP-WUS configuration type, wherein the first LP-WUS configuration type comprises one or more parameters associated with LP-WUS-triggered monitoring of connected-mode discontinuous reception (C-DRX) downlink control resources, and wherein the second LP-WUS configuration type comprises one or more parameters associated with LP-WUS-triggered monitoring of non-C-DRX downlink control resources;
receive an activation command that activates monitoring of LP-WUS monitoring occasions according to a first configuration of the one or more configurations of the first LP-WUS configuration type, a second configuration of the one or more configurations of the second LP-WUS configuration type, or both; and
receive a physical downlink control channel (PDCCH) during a PDCCH monitoring occasion in accordance with the first configuration, the second configuration, or both.
